(19) United States
(12) Patent Application Publication
(10) Pub. No.: US 2008/0037296 A1
(43) Pub. Date: Feb. 14, 2008

(54) Green-mode flyback pulse width modulation apparatus

(76) Inventors: Ta-Ching Hsu, Taipei (TW); Hui-Chiang Yang, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/500,349

(22) Filed: Aug. 8, 2006

(51) Int. Cl. H02M 1/12

(52) U.S. Cl. 363/41

(57) ABSTRACT

A green-mode flyback pulse width modulation apparatus adopting a bipolar transistor structure IC process is used in a power supply. An oscillator circuit outputs a periodic clock signal to a control terminal of a power switch through an amplifier circuit for periodically turning on the power switch. A latch circuit is connected to the oscillator circuit, the amplifier circuit, the power switch and a feedback terminal of the power supply for periodically pulling down the potential at a control terminal of the power switch in response to a feedback signal generated by the feedback terminal to turn off the power switch and continue suspending the operation of the oscillator circuit when the power supply is at a light load, and will resume the output of the oscillator circuit till the potential of the feedback signal potential drops, so as to achieve the green-mode function.

### BACKGROUND OF THE INVENTION

1. Field of the Invention

The present invention relates to a green-mode flyback pulse width modulation apparatus, and more particularly to a pulse width modulation apparatus made by a bipolar transistor integrated circuit fabrication process and used in a power supply for controlling and switching a power switch.

2. Description of Related Art

As a traditional DC power supply such as an AC-to-DC switching power supply usually uses a high-frequency pulse width modulation (PWM) controlled output DC voltage to reduce the size of a transformer. Referring to FIG. 1 for a schematic circuit diagram of a prior art flyback power supply, the transformer T1 divides the circuit into a primary side 101 and a secondary side 102. Electric signals of the primary side 101 and the secondary side 102 are separated by a phototransistor 111 and a photodiode 112 installed between the primary side 101 and the secondary side 102, but the voltage or current at an optical signal feedback secondary side 102 outputs a change signal to the primary side 101 to synchronously modulate the pulse width of switch of the primary side 101 or serve as a feedback signal for over-current and short-circuit protections.

In FIG. 1, the primary side 101 input an AC voltage VAC, and the AC voltage VAC becomes a DC voltage Vin after passing through an EMI filter 1010, a bridge rectified diode BD1 and a high-voltage filter capacitor C1. The DC voltage Vin provides the current via primary winding of a transformer T1 and power transistor switch Q1 in the conduction cycle of a power transistor switch Q1 by a pulse width modulation control unit U1 and storages the energy in the transformer T1 due to opposite polarity of D1. After the power switch Q1 is off, the secondary winding of the transformer T1 provides the current to the output. After the output voltage is rectified and filtered by a diode D1 and an electrolytic capacitor C2, a stable DC voltage Vout will be outputted.

The DC voltage Vout converts the outputted DC voltage Vout into a voltage signal VFB by a zener diode D3 and a photocoupler 11 and feeds back the voltage signal VFB to a pulse width modulation control unit U1 of the primary side 101. In the meantime, the resistor R2 obtains a current feedback signal Vcs when the power transistor switch Q1 is conducted, and the current feedback signal Vcs is sent to the pulse width modulation control unit U1, and the pulse width modulation control unit U1 obtains the current feedback signal Vcs and the voltage signal VFB to compute and output a pulse width modulation PWM to the power transistor switch Q1 for stabilizing the outputted DC voltage Vout.

Based on the concept of environmental protection, the green-mode power supply becomes increasingly popular, and pulse width modulation controller (PWM IC) designers and manufacturers spare no effort to introduce a new-generation green-mode pulse width modulation controller (PWM IC) to replace the old products. Most green-mode pulse width modulation controllers (PWM IC) are designed and fabricated by a complimentary metal oxide semiconductor (CMOS) structure IC process, but the complimentary metal oxide semiconductor (CMOS) structure IC has a drawback of a poor voltage resistance. For improper designs, defects are commonly found in the electrostatic discharge (ESD) and surge tests. The design of the new-generation green-mode pulse width modulation controller (PWM IC) comes with a complicated circuitry and adopts many components, and thus such design cannot adopt the bipolar transistor structure IC process for the fabrication, because the bipolar transistor structure IC process has a large transistor area and consumes much electric power. Furthermore, the price of the green-mode pulse modulation controller (PWM IC) is higher than a general pulse width modulation controller (PWM IC).

### SUMMARY OF THE INVENTION

In view of the foregoing shortcomings, the present invention provides a green-mode flyback pulse width modulation apparatus.

To overcome the foregoing problems of the prior art, a solution of the present invention provides green-mode flyback pulse width modulation apparatus to improve the aforementioned issues of poor voltage resistance and high price due to a complimentary metal oxide semiconductor (CMOS) structure IC process.

A green-mode flyback pulse width modulation apparatus in accordance with the present invention adopting a bipolar transistor structure IC process is used in a power supply for controlling a power switch for switching on and off. The invention uses an oscillator circuit to receive an auxiliary power voltage through an auxiliary power terminal of the power supply and outputs a periodic clock signal. The periodic clock signal is sent to a control terminal of a power switch through an amplifier circuit for periodically turning on the power switch. In the meantime, a latch circuit is connected to the oscillator circuit, the amplifier circuit, the power switch and a feedback terminal of the power supply. The potential at a control terminal of the power switch is pulled down periodically in response to a feedback signal generated by the feedback terminal to turn off the power switch. Further, when the power supply is at a light load, the potential of the feedback signal becomes high, so that the latch circuit continues suspending the operation of the oscillator circuit, and will resume the output of the oscillator circuit till the potential of the feedback signal drops, so as to achieve the green-mode function.

To make it easier for our examiner to understand the innovative features and technical content, we use a preferred embodiment together with the attached drawings for the detailed description of the invention, but it should be pointed out that the attached drawings are provided for reference and description but not for limiting the present invention.

### BRIEF DESCRIPTION OF THE DRAWINGS

FIG. 1 is a schematic circuit diagram of a prior art flyback power supply;

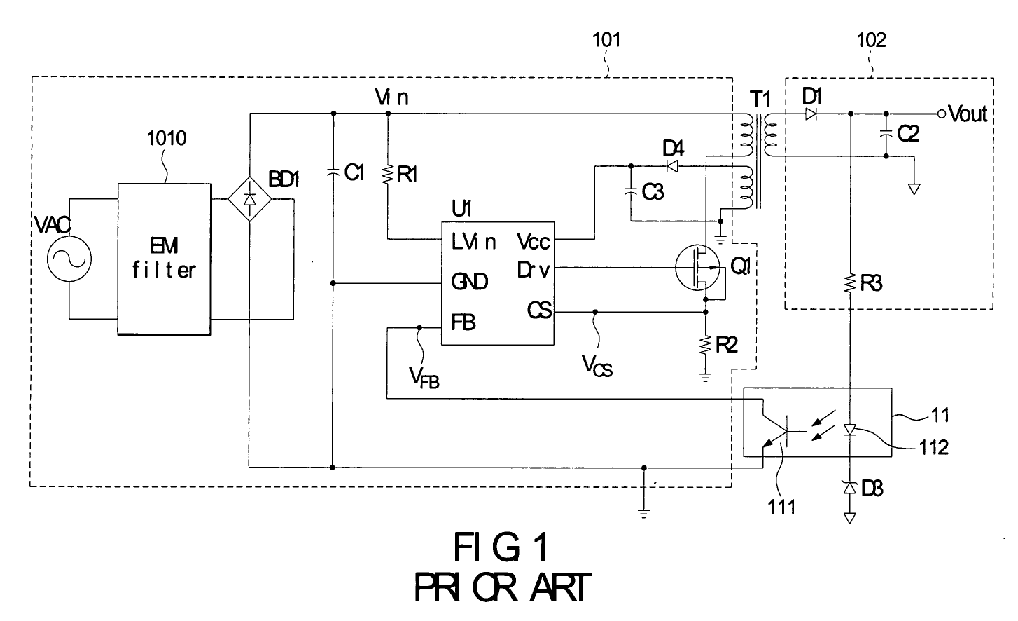

FIG. 2 is a schematic circuit diagram of the present invention;

FIG. 3 is a schematic waveform diagram of each point of a circuit of a power supply at a normal load in accordance with the present invention; and

FIG. 4 is a schematic waveform diagram of each point of a circuit of a power supply at a light load in accordance with the present invention.

### DETAILED DESCRIPTION OF THE PREFERRED EMBODIMENTS

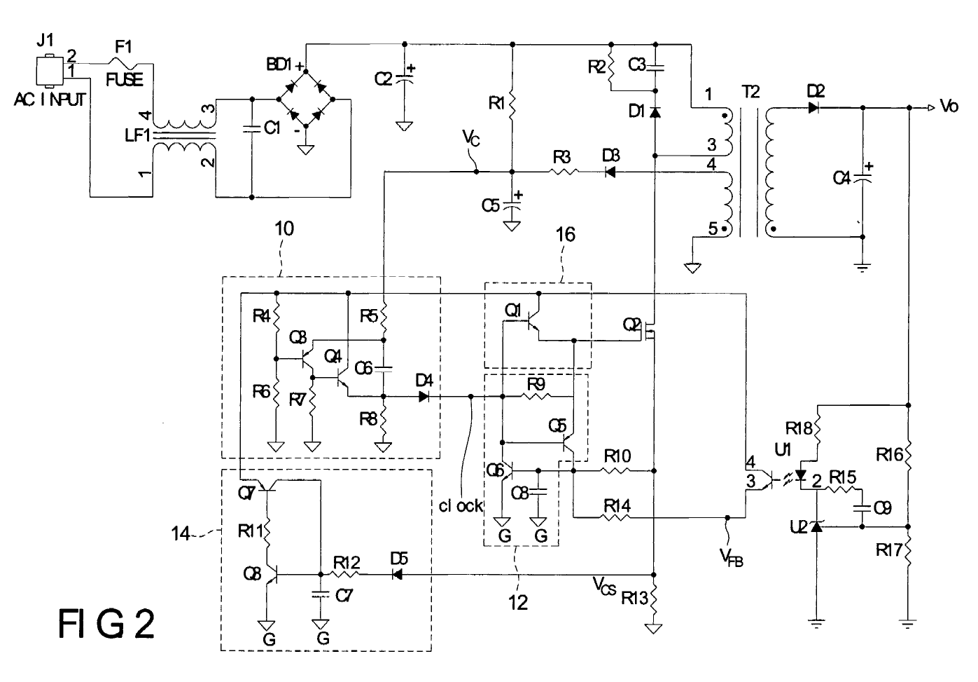

Referring to FIG. 2 for a schematic circuit diagram of the present invention, a green-mode flyback pulse width modulation apparatus is fabricated by a bipolar transistor structure IC fabrication process and used in a power supply for controlling and switching a power switch Q2. The apparatus of the present invention comprises: an oscillator circuit 10, a latch circuit 12 and an amplifier circuit 16.

In FIG. 2, the oscillator circuit 10 is connected to an auxiliary power terminal VC of the power supply for receiving an auxiliary power voltage and outputting a periodic clock signal CLOCK, and the periodic clock signal CLOCK is sent to a control terminal of the power switch Q2 through the amplifier circuit 16 for periodically turning on the power switch Q2, and the amplifier circuit 16 is a third transistor Q1 with its base terminal connected to the oscillator circuit 10, its collector terminal connected to the auxiliary power terminal VC, and its emitter terminal connected to a control terminal of the power switch Q2, and the amplified circuit 16 is an emitter follower. In the meantime, the latch circuit 12 is connected to the oscillator circuit 10, the amplifier circuit 16, the power switch Q2 and a feedback terminal FB of the power supply for periodically pulling down the potential at a control terminal of power switch Q2 in response to a feedback signal VFB generated by the feedback terminal FB to turn off the power switch Q2. Therefore, the present invention can control the periodical conduction and cutoff of the power switch Q2, so that the power supply can stably output and supply the required electric power to the load, when the power supply is operated normally.

When the power supply is at a light load, the potential of the feedback signal VFB remains high for a while, so that the latch circuit 12 continues suspending the operation of the oscillator circuit 10 and will resume the output of the oscillator circuit 10 till the potential of the feedback signal VFB drops.

Referring to FIG. 2, the apparatus of the invention further comprises a short-circuit protection circuit 14 connected to an auxiliary power terminal VC and a current detection resistor R13 for obtaining a current detection signal VCS built on the current detection resistor R13. If the current detection signal VCS is greater than a predetermined protection threshold set by the short-circuit protection circuit 14, then the short-circuit protection circuit 14 will pull down the voltage of the auxiliary power, and thus no sufficient voltage will be supplied for the normal operation of the oscillator circuit 10, so as to achieve the protection for short circuit at a load of the power supply.

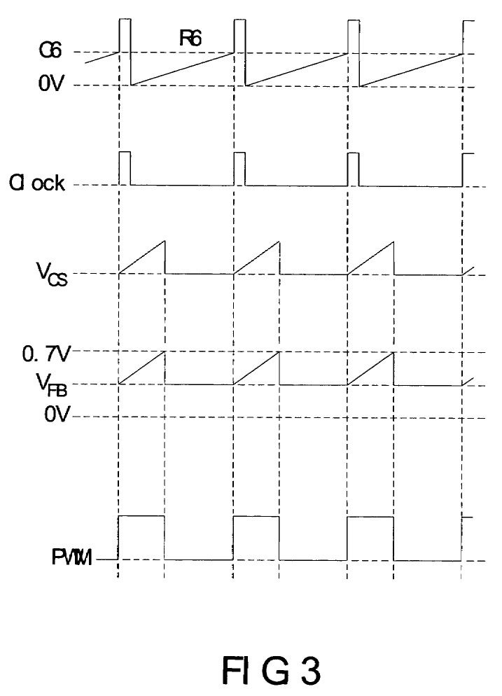

Referring to FIGS. 2 and 3 for a schematic circuit diagram and a schematic waveform diagram of each point in the circuit of a power supply at a normal load, the oscillator circuit 10 is made by connecting components such as transistors Q3, Q4, and its periodic clock signal CLOCK is produced as follows; a capacitor C6 in the oscillator circuit 10 is connected to an auxiliary power terminal VC of the power supply through a resistor R5 for receiving an auxiliary power voltage, and charging electricity. If the voltage of the capacitor C6 is charged to the threshold voltage level that is greater than the sum of the voltage at a base-emitter (B-E) junction of the transistor Q3 and divided voltage at the resistor R6, the transistor Q3 will be conducted with the transistor Q4. Now, an output terminal of a diode D4 will generate a clock signal CLOCK, and then the capacitor C6 will discharge electricity through an electric discharge path and then will charge electricity again as described previously. Therefore, the oscillator circuit 10 can use the capacitor C6 to charge and discharge electricity repeatedly to output the periodic clock signal CLOCK.

In FIG. 2, the latch circuit 12 comprises; a first transistor Q6 with its collector terminal connected to the output terminal of the oscillator circuit 10, its emitter terminal connected to a reference terminal G, and its base terminal connected to a feedback terminal FB of the power supply; a second transistor Q5 with its collector terminal connected to a base terminal of the first transistor Q6, its emitter terminal connected to a control terminal of the power switch Q2, and its base terminal connected to a collector terminal of the first transistor Q6. A filter capacitor C8 has an end connected to a feedback terminal FB of the power supply and another end connected to the reference terminal G. A bias resistor R9 is connected to a base terminal and an emitter terminal of the second transistor Q5, wherein the first transistor Q6 and the second transistor Q5 are equivalent to a silicon controlled rectifier (SCR) having the features of a silicon controlled rectifier (SCR).

In FIGS. 2 and 3, if the power supply is operated normally, the oscillator circuit 10 will outputs a periodic clock signal CLOCK to the power switch Q2 through the amplifier circuit 16 for controlling its electric conduction, and the current detection resistor R13 will receive a current passing through the power switch Q2 to generate a current detection signal VCS, and the latch circuit 12 will receive the current detection signal VCS and the feedback signal VFB of the power supply. If the sum of voltages of these two signals is greater than a predetermined voltage at the base-emitter (B-E) junction of the first transistor Q6 in the latch circuit 12, the first transistor Q6 and the second transistor Q5 will be conducted electrically to pull down of the potential at the control terminal of the power switch Q2 and turn off the power switch Q2. Therefore, the invention can use the oscillator circuit 10 to output a periodic clock signal CLOCK and operate with a latch circuit 12 to output a periodic PWM control signal to a gate of the power switch Q2, so as to control and switch the power switch Q2 and stabilize the output power of the power supply to supply stable electric power required by a load.

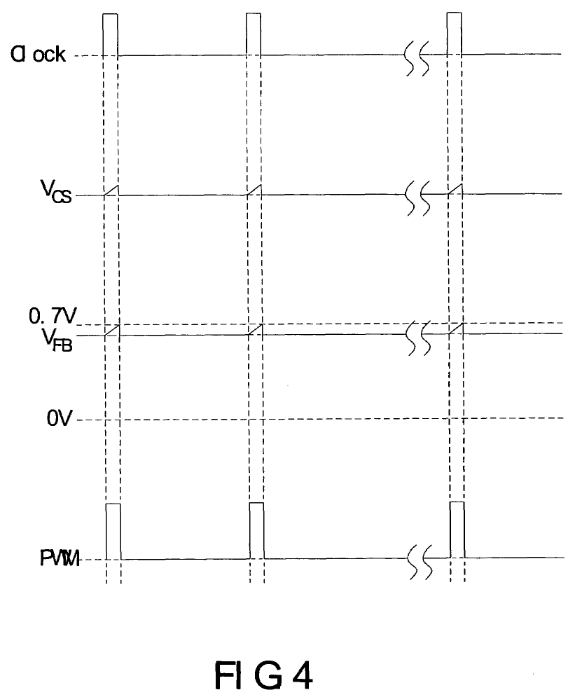

Referring to FIGS. 2 and 4 for a schematic circuit diagram and a schematic waveform diagram of a power supply at a light load, the feedback signal VFB of the power supply will be pulled high if the power supply is operated at a light load, and the sum of voltages of the feedback signal VFB and the current detection signal VCS will soon reach the voltage at the base-emitter (B-E) junction of the first transistor Q6 in the latch circuit 12, so that the first transistor Q6 and the second transistor Q5 will be conducted, and the potential at the control terminal of the power switch Q2 will be pulled low to turn off the power switch Q2. When the power supply is at a light load, the invention outputs a periodic PWM control signal with a duty cycle smaller than that being operated at a normal load, so that the power supply will output and supply a stable electric power to the load.

When the power supply is at a light load, a latch circuit 12 of the present invention obtains a feedback signal VFB from a feedback terminal FB of the power supply to maintain the high potential, and the feedback signal VFB of the latch circuit 12 remained at a high potential continues suspending the operation of the oscillator circuit 10, and will resume the output of the oscillator circuit 10 till the potential of the feedback signal VFB drops, so as to achieve the green-mode function.

In summation of the description above, the green-mode flyback pulse width modulation apparatus in accordance with the present invention is fabricated by a bipolar transistor structure IC fabrication process and used in a power supply for controlling the power switch to switch on and off. An oscillator circuit of the invention receives an auxiliary power voltage through an auxiliary power terminal in the power supply and outputs a periodic clock signal, and the periodic clock signal is sent to a control terminal of the power switch through an amplifier circuit for periodically turning on the power switch. In the meantime, a latch circuit is connected to the oscillator circuit, the amplifier circuit, the power switch and a feedback terminal of the power supply for periodically pulling down the potential at a control terminal of the power switch in response to a feedback signal generated by the feedback terminal to turn off the power switch.

When the power supply is at a light load, the potential of the feedback signal becomes high for a while, such that the latch circuit continues suspending the operation of the oscillator circuit and will resume the output of the oscillator circuit till the potential of the feedback signal potential drops, so as to achieve the green-mode function.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A green-mode flyback pulse width modulation apparatus, adopting a bipolar transistor structure IC process and being used in a power supply, for controlling and switching a power switch, comprising;
an oscillator circuit, coupled to an auxiliary power terminal of said power supply for receiving an auxiliary power voltage and outputting a periodic clock signal to a control terminal of said power switch through an amplifier circuit, for periodically turning on said power switch; and
a latch circuit coupled to said oscillator circuit, said amplifier circuit, said power switch and a feedback terminal of said power supply for periodically pulling down a potential of said control terminal of said power switch in response to a feedback signal generated by said feedback terminal to turn off said power switch, and responsive to said feedback signal being at a high potential when said power supply is at a light load, said latch circuit suspends the operation of said oscillator circuit, said latch circuit resumes the output of said oscillator circuit responsive to the potential of said feedback signal dropping below a threshold value.

2. The green-mode flyback pulse width modulation apparatus of claim 1, further comprising a short-circuit protection circuit coupled to said auxiliary power terminal and a current detection resistor for obtaining a current detection signal across said current detection resistor, the voltage of said auxiliary power being pulled down to supply an insufficient voltage for the normal operation of said oscillator circuit responsive to said current detection signal being greater than a predetermined protection threshold.

3. The green-mode flyback pulse width modulation apparatus of claim 1, wherein said latch circuit comprises:
a first bipolar transistor, with its collector terminal coupled to said oscillator circuit, its emitter terminal coupled to a reference terminal, and its base terminal coupled to a feedback terminal of said power supply;
a second bipolar transistor, with its collector terminal coupled to said base terminal of said first bipolar transistor, its emitter terminal coupled to said control terminal of said power switch, and its base terminal coupled to said collector terminal of said first bipolar transistor;
a filter capacitor, with an end coupled to a feedback terminal of said power supply and another end coupled to said reference terminal; and a bias resistor, coupled to said base terminal and said emitter terminal of said second bipolar transistor.

4. The green-mode flyback pulse width modulation apparatus of claim 1, wherein said amplifier circuit is an emitter follower.

5. The green-mode flyback pulse width modulation apparatus of claim 1, wherein said amplifier circuit includes a bipolar transistor having a base terminal coupled to said oscillator circuit, a collector terminal coupled to said auxiliary power terminal, and an emitter terminal coupled to a control terminal of said power switch.

6. The green-mode flyback pulse width modulation apparatus of claim 1, wherein the oscillator circuit comprises a capacitor and at least one transistor coupled to said capacitor and said capacitor drives said bipolar transistor to periodically conduct so as to output said periodic clock signal by charging and discharging repeatedly.

7. The green-mode flyback pulse width modulation apparatus of claim 6, wherein said bipolar transistor is held in a conducting state so that said oscillator circuit is suspended from outputting said periodic clock signal responsive to as said power switch being at a light load.

8. A green-mode flyback pulse width modulation apparatus, being used in a power supply, for controlling and switching a power switch, comprising:
an oscillator circuit, outputting a periodic clock signal to a control terminal of said power switch through an amplifier circuit for turning on said power switch periodically, comprising:
a first bipolar transistor;
a second bipolar transistor, with a base terminal coupled to the collector terminal of said first bipolar transistor so as to be conducted by said first bipolar transistor; and
a capacitor, with a first terminal coupled to an auxiliary power terminal of said power supply and the emitter of said first bipolar transistor for charging and conducting said first bipolar transistor, and a second terminal coupled to an electric discharge path for discharging, wherein as the voltage value of the first terminal of said capacitor exceeds the threshold voltage level of a base-emitter (B-B) junction of said first bipolar transistor, said first bipolar transistor is conducted with said second bipolar transistor, wherein said capacitor charges and discharges repeatedly to change the voltage value of the first terminal of said first capacitor so as to conduct said first bipolar transistor and said second bipolar transistor periodically so as to output said periodic clock signal;
a latch circuit coupled to said oscillator circuit, said amplifier circuit, said power switch and a feedback terminal of said power supply, for periodically pulling down the potential of said control terminal of said power switch in response to a feedback signal generated by said feedback terminal to turn off said power switch, responsive to said feedback signal being at a high potential when said power supply is at a light load, said latch circuit suspends the operation of said oscillator circuit, said latch circuit resumes the output of said oscillator circuit responsive to the potential of said feedback signal dropping below a threshold value.

9. The green-mode flyback pulse width modulation apparatus of claim 8, wherein said first bipolar transistor and said second bipolar transistor are held in a conducting state so that said oscillator circuit is suspended from outputting said periodic clock signal responsive to as said power switch being at a light load.

10. The green-mode flyback pulse width modulation apparatus of claim 8, further comprising a short-circuit protection circuit, coupled to said auxiliary power terminal and a current detection resistor, for obtaining a current detection signal built on said current detection resistor, such that if said current detection signal is greater than a predetermined protection threshold, the voltage of said auxiliary power will be pulled down, such that an insufficient voltage will be supplied for the normal operation of said oscillator circuit.

11. The green-mode flyback pulse width modulation apparatus of claim 8, wherein said latch circuit comprises:
a first transistor, with a collector terminal coupled to said oscillator circuit, a emitter terminal coupled to a reference terminal, and a base terminal coupled to a feedback terminal of said power supply;
a second transistor, with a collector terminal coupled to said base terminal of said first transistor, an emitter terminal coupled to said control terminal of said power switch, and a base terminal coupled to said collector terminal of said first transistor;
a filter capacitor, with an end coupled to a feedback terminal of said power supply and another end coupled to said reference terminal; and
a bias resistor, coupled to said base terminal and said emitter terminal of said second transistor.

12. The green-mode flyback pulse width modulation apparatus of claim 8, wherein said amplifier circuit is an emitter follower.

13. The green-mode flyback pulse width modulation apparatus of claim 8, wherein said amplifier circuit includes a bipolar transistor having a base terminal coupled to said oscillator circuit, a collector terminal coupled to said auxiliary power terminal, and an emitter terminal coupled to a control terminal of said power switch.
